(19) United States
(12) Patent Application Publication
(10) Pub. No.: US 2025/0196586 A1
(43) Pub. Date: Jun. 19, 2025

(54) VENTILATOR ASSEMBLY, VENTILATION SYSTEM, AND MOTOR VEHICLE

(71) Applicant: MAHLE International GmbH, Stuttgart (DE)

(72) Inventors: Joachim RAPP, Stuttgart (DE); Erich LITWING, Stuttgart (DE)

(21) Appl. No.: 18/975,900

(22) Filed: Dec. 10, 2024

(30) Foreign Application Priority Data
Dec. 15, 2023 (DE) 102023135366.7

(51) Int. Cl. B60H 1/24; B60H 1/00

(52) U.S. Cl. CPC B60H 1/247; B60H 1/00842

(57) ABSTRACT

A ventilator assembly is provided. The ventilator assembly includes
at least one fan, and
a diffusor, which opens into at least a first air discharge channel, a second air discharge channel, and a third air discharge channel,
   wherein a first louvre that can pivot about a first axis is placed in the first air discharge channel, a second louvre that can pivot about a second axis is placed in the second air discharge channel, and a third louvre that can pivot about a third axis is placed in the third air discharge channel, to control the respective air flows, and wherein the first axis, second axis, and third axis are parallel to one another.

### CROSS-REFERENCE TO RELATED APPLICATIONS

This application claims priority from German Patent Application No. DE 10 2023 135 366.7 filed Dec. 15, 2023, the entirety of which is hereby incorporated by reference herein.

The present invention relates to a ventilator assembly. The invention also relates to a ventilation system that has two such ventilator assemblies, and a motor vehicle that has such a ventilation system.

The installation space in modern motor vehicles for ventilator assemblies is extremely limited, and also severely restricted by different geometrical factors. These different and complex geometries are also dictated by the placement of the air vents at different locations in the motor vehicle. Moreover, the complex assembly processes for the housings of these ventilator assemblies are also a factor.

The disadvantage with this is that, aside from the difficult assembly processes, it is not possible to use identical parts, which would result in significantly lower production costs. The different assembly processes are also comparatively complicated and therefore expensive.

The present invention addresses the problem of creating a better or at least different ventilator assembly with which the disadvantages from the prior art, specifically with regard to the complex assembly processes, can be overcome.

This problem is solved by the invention with the subject matter of the independent claim 1. Advantageous embodiments are the subject matter of the dependent claims.

The present invention is based on the general concept of placing the air vents, also referred to simply as “louvres” below, as far as possible from a diffusor outlet, such that the louvres can be positioned more easily, and shaped independently of where the air is discharged. By moving the individual louvres, they can also have parallel axes, which also simplifies the installation of the stepper motors operating the louvres. The ventilator assembly obtained with the invention contains at least one fan, e.g. a radial fan, a diffusor, which has the fan at the intake end and opens into at least one first air discharge channel, one second air discharge channel, and one third air discharge channel at the outlet end. A first louvre is placed in the first air discharge channel, which can pivot about a first axis, a second louvre is placed in the second air discharge channel, which can pivot about a second axis, and a third louvre is placed in the third air discharge channel, which can pivot about a third axis, all of which control respective air flows. All three axes are parallel, allowing for the stepper motors that actuate the louvres to be placed on the same side of the air discharge channels, and installed from the same direction. This results not only in an extremely easy installation process, which is therefore less expensive, but it also reduces the complexity of the kinematics to a minimum.

An advantageous embodiment of the ventilator assembly obtained with the invention contains a stepper motor with a cam plate, with which at least two louvres can be operated. This results in the major advantage that, unlike with an embodiment in which each louvre has a separate motor, at least two louvres can be operated with just one stepper motor, thus reducing the number of necessary motors, and significantly reducing the production costs.

In an advantageous embodiment of the ventilator assembly obtained with the invention, a radial fan is placed at the intake end of the diffusor. A radial fan normally takes air in axially, and deflects it 90° as it is discharged. This results in a radial discharge direction in relation to the rotational axis, by which means higher pressures can be obtained, or greater pressure losses can be overcome, than with axial fans. Consequently, the fans do not have to be as large, which is not only advantageous with regard to the available installation space, but also reduces weight and costs.

In a particularly preferred embodiment of the ventilator assembly obtained with the invention, the first air discharge channel is above the second, and the second is above the third. This results in a particularly compact assembly, which also reduces the necessary installation space. The individual air discharge channels can ventilate separate areas in a motor vehicle, e.g. the lower, middle and upper areas.

The present invention is also based on the general concept of creating a ventilation system with two of the above ventilator assemblies, in which the two ventilator assemblies are placed in relation to one another such that a first axis of the first ventilator assembly is coaxial to a first axis of the second ventilator assembly, a second axis of the first ventilator assembly is coaxial to a second axis of the second ventilator assembly, and a third axis of the first ventilator assembly is coaxial to a third axis of the second ventilator assembly. The first two louvres are therefore also coaxial to one another, as are the second and third louvres. The stepper motors for operating the respective louvres in the two ventilator assemblies can be placed opposite the two ventilator assemblies, resulting in a particularly space-saving design of the ventilation system. Moreover, the advantages obtained with the ventilator assemblies described above also apply to the ventilation system obtained with the invention.

In a particularly preferred embodiment of the ventilation system obtained with the invention, the two ventilator assemblies are mirror-symmetrical to one another. This has the advantage that the individual ventilator assemblies can first be assembled separately, in which the respective stepper motors have a their own orientation, such that the two ventilator assemblies can be connected to one another in the middle. The part in the middle can then be more robust and form a supporting element.

In an advantageous embodiment of the ventilation system, each ventilator assembly has an intake nozzle, the outlet ends of which are between the two ventilator assemblies when the ventilation system has been installed. The outlets of these intake nozzles are not only between the two fans, but also between the two diffusors for the two ventilator assemblies, resulting in a particularly space-saving assembly. The widths of the two intake nozzles taper toward the two fans, and the diffusors become wider from the fans toward the individual air discharge channels. This results in a particularly space-saving arrangement of the intake nozzles and the diffusors, as well as the downstream air discharge channels, because the tapering of the intake nozzles and diffusors near the fans reduces the widths of the intake nozzles at their intake ends, and the diffusors at their outlet ends, as well as the air discharge channels.

The present invention is also based on the general concept of equipping a motor vehicle with the ventilation system described above, such that the advantages obtained therewith can also be obtained for the motor vehicle. These advantages relate specifically to a structure optimized to the installation space, and a particularly simple installation, because the axes of the individual louvres for controlling the respective air flows in the various air discharge channels are parallel to one another, such that the stepper motors for moving the individual louvres can be installed from a single direction.

The ventilation system is ideally placed in a central console in the motor vehicle. Because of the optimized structure of the ventilation system obtained with the invention with regard to installation space, it can be placed in a central console in a motor vehicle, such that individual areas can be ventilated separately by the six different air discharge channels. Because of the two different ventilator assemblies in the ventilation system, it is possible to ventilate the areas behind the driver's seat and the front passenger seat separately, e.g. in the lower, middle and upper areas. This results in a particularly high comfort level.

Other features and advantages of the invention can be derived from the dependent claims, the drawings, and the descriptions of the drawings.

It is understood that the features specified above and described below can be used not only in the given combinations, but also in other combinations or in and of themselves, without abandoning the scope of the present invention. Components of a higher order unit specified above or below, e.g. a mechanism, device, or assembly, which are indicated separately, can be separate parts or components of these units or integral parts or sections thereof, even if the drawings indicate otherwise.

Preferred exemplary embodiments of the invention are shown in the drawings and shall be explained in greater detail below, in which the same reference symbols are used for identical, similar, or functionally identical components.

Therein, schematically:

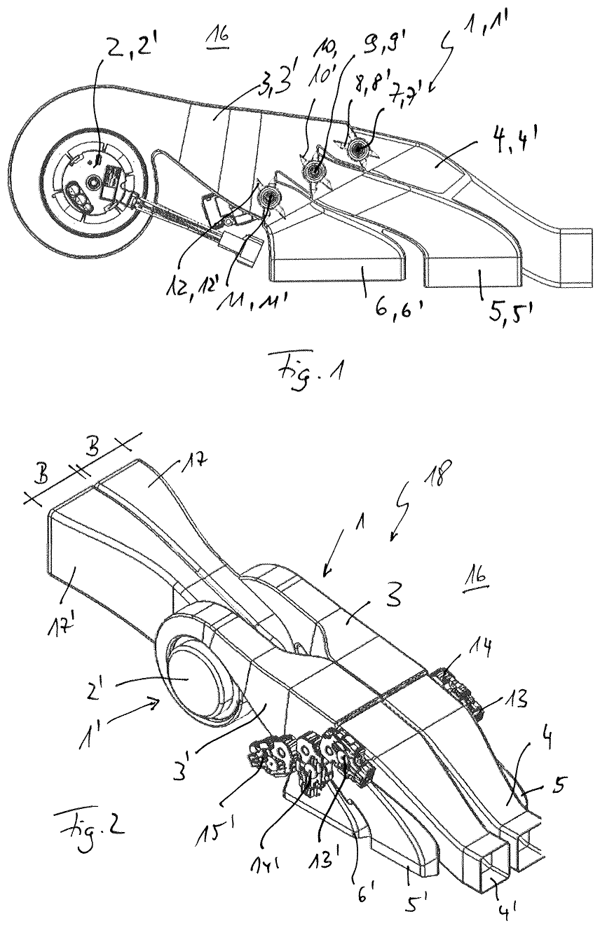

FIG. 1 shows a sectional view of a ventilator assembly obtained with the invention;

FIG. 2 shows a ventilation system obtained with the invention with two ventilator assemblies;

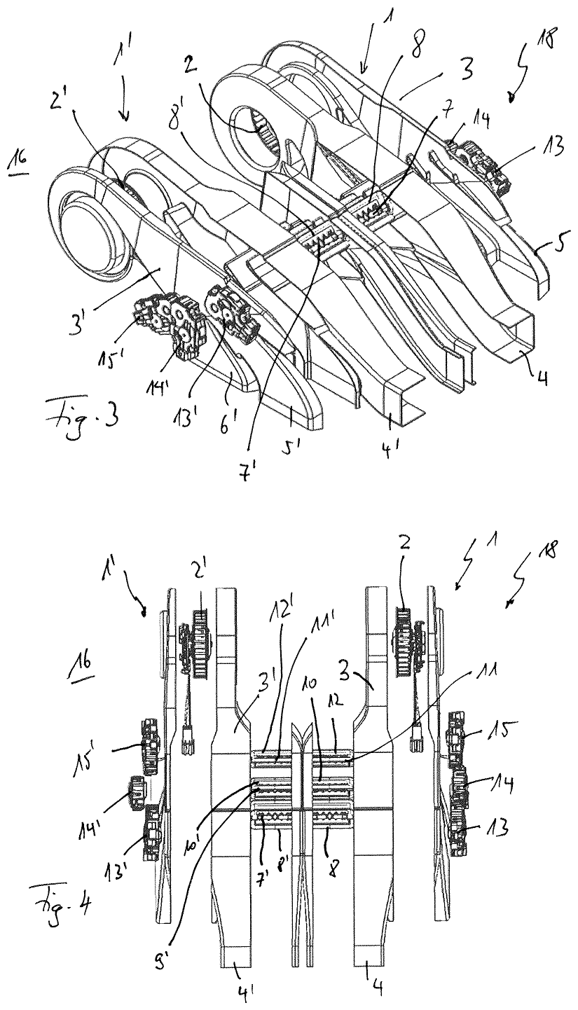

FIG. 3 shows an exploded view of the fan system shown in FIG. 2; and

FIG. 4 shows the fan system shown in FIG. 3 from above.

Identical components in the two ventilator assemblies 1, 1′ have the same reference symbols in the following descriptions of the drawings, but with apostrophes, in order to distinguish between the two ventilator assemblies in the ventilation system.

The ventilator assemblies 1, 1′ shown in FIGS. 1 to 4 each contain a fan 2, 2′, and a diffusor 3, 3′, which open at their outlet ends into at least one first air discharge channel 4, one second air discharge channel 5, 5′, and one third air discharge channel 6, 6′. There is a first louvre 8, 8′ in the first air discharge channel 4, 4′, which can pivot about a first axis 7, 7′, a second louvre 10, 10′ in the second air discharge channel 5, 5′, which can pivot about a second axis 9, 9′, and a third louvre 12 in the third air discharge channel 6, 6′, which can pivot about a third axis 11, 11′, for controlling the respective air flows. The first axis 7, 7′, second axis 9, 9′, and third axis 11, 11′ are orthogonal to the drawing plane in FIG. 1, and thus parallel to one another.

There is a first stepper motor 13, 13′ (see FIGS. 2-4) for pivoting the first louvre 8, 8′, a second stepper motor 14, 14′ for pivoting the second louvre 10, 10′, and a third stepper motor 15, 15′ for pivoting the third louvre 12, 12′, all of which are on the same side of the respective diffusors 3, 3′ and the same side of the respective air discharge channels 4, 4′, 5, 5′, 6, 6′, thus allowing them to be installed from the same direction. This significantly reduces the installation difficulty for the ventilator assemblies 1, 1′ compared to ventilator assemblies from the prior art, in which the individual axes of the respective louvres are not parallel to one another.

Instead of a separate motor 13, 13′, 14, 14′, 15, 15′ for each louvre 8, 8′, 10, 10′ and 12, a stepper motor with a cam plate can operate at least two louvres 8, 8′, 10, 10′, 12, 12′. The number of motors 13, 13′, 14, 14′, 15, 15′ can consequently be reduced, reducing the necessary installation space and weight, as well as significantly reducing costs.

The fan 2, 2′ is at the intake end of the diffusor 3, 3′, and can be a radial fan, through which air can enter axially, and be discharged radially. This type of radial fan can generate higher pressures, such that smaller, lighter, and less expensive fans can be used to obtain the same performance.

A closer examination of FIGS. 1 and 2 shows that the first air discharge channel 4, 4′ is connected to the diffusor 3, 3′ above the second air discharge channel 5, 5′, and the second air discharge channel 5, 5′ is connected to the diffusor 3, 3′ above the third air discharge channel 6, 6′. The first louvre 8, 8′ is also above the second louvre 10, 10′, and above the third louvre 12, 12′. The footwell area can be ventilated with the third air discharge channel 6, 6′, and air vents in a central console in a motor vehicle 16 can be supplied with air from the first air discharge channel 4, 4′.

Each fan 2, 2′ in the respective ventilator assembly 1, 1′ is connected to an intake nozzle 17, 17′ at the intake end (see FIG. 2), the width B of which tapers toward the respective fan 2, 2′.

FIGS. 2-4 show a ventilation system 18 obtained with the invention, which contains two of the ventilator assemblies 1, 1′ shown in FIG. 1, which are placed in relation to one another such that a first axis 7 of the first ventilator assembly 1 is coaxial to a first axis 7′ of the second ventilator assembly 1′, a second axis 9 of the first ventilator assembly 1 is coaxial to a second axis 9′ of the second ventilator assembly 1′, and a third axis 11 of the first ventilator assembly 1 is coaxial to a third axis 11′ of the second ventilator assembly 1′. The two ventilator assemblies 1, 1′ are mirror-symmetrical to one another, such that the respective stepper motors 13, 13′, 14, 14′, 15, 15′ can be attached to their ventilator assemblies 1, 1′ from the same direction.

The outlets of the two intake nozzles 17, 17′ to the respective fans 2, 2′ are between the two fans 2, 2′ and diffusors 3, 3′, reducing the overall width, such that it can be more easily integrated in a central console in the motor vehicle 16. These two ventilator assemblies 1, 1′ also enable separate ventilation of the two front seats in the motor vehicle 16 obtained with the invention, significantly increasing the comfort of the passengers in the motor vehicle 16.

On the whole, a structure can be obtained with the ventilator assembly 1, 1′, ventilation system 18, and motor vehicle 16 obtained with the invention that is optimized for the available installation space, and significantly easier to install, because the axes 7, 7′, 9, 9′, 11, 11′ of the separate louvres 8, 8′, 10, 10′, 12, 12′ are parallel to one another, and coaxial to one another in the two ventilator assemblies 1, 1′ in the ventilation system 18 obtained with the invention.

The individual air discharge channels 4, 4′, 5, 5′, 6, 6′ can be inexpensively produced with two-part injection-molded housings made of plastic.

The specification can be readily understood with reference to the following Numbered Paragraphs:
Numbered Paragraph 1. A ventilator assembly (1, 1′), comprising
   at least one fan (2, 2′), and
   a diffusor (3, 3′), which opens into at least a first air discharge channel (4, 4′), a second air discharge channel (5, 5′), and a third air discharge channel (6, 6′),
   wherein a first louvre (8, 8′) that can pivot about a first axis (7, 7′) is placed in the first air discharge channel (4, 4′), a second louvre (10, 10′) that can pivot about a second axis (9, 9′) is placed in the second air discharge channel (5, 5′), and a third louvre (12, 12′) that can pivot about a third axis (11, 11′) is placed in the third air discharge channel (6, 6′), to control the respective air flows, and wherein the first axis (7, 7′), second axis (9, 9′), and third axis (11, 11′) are parallel to one another.
Numbered Paragraph 2. The ventilator assembly according to Numbered Paragraph 1, characterized in that there is a first stepper motor (13, 13′) for pivoting the first louvre (8, 8′), a second stepper motor (14, 14′) for pivoting the second louvre (10, 10′), and a third stepper motor (15, 15′) for pivoting the third louvre (12, 12′), all of which are on the same sides of the respective air discharge channels (4, 4′, 5, 5′, 6, 6′).
Numbered Paragraph 3. The ventilator assembly according to Numbered Paragraph 1, characterized in that at least one stepper motor (13, 13′, 14, 14′, 15, 15′) has a cam plate with which at least two louvres (8, 8′, 10, 10′, 12, 12′) can be operated.
Numbered Paragraph 4. The ventilator assembly according to any of the preceding Numbered Paragraphs, characterized in that the fan (2, 2′) is a radial fan.
Numbered Paragraph 5. The ventilator assembly according to any of the preceding Numbered Paragraphs, characterized in that the first air discharge channel (4, 4′) is above the second air discharge channel (5, 5′), and the second air discharge channel (5, 5′) is above the third air discharge channel (6, 6′).
Numbered Paragraph 6. A ventilation system (18) with two ventilator assemblies (1, 1′) according to any of the preceding Numbered Paragraphs, wherein the two ventilator assemblies (1, 1′) are placed in relation to one another such that a first axis (7) of the first ventilator assembly (1) is coaxial to a first axis (7′) of the second ventilator assembly (1′), a second axis (9) of the first ventilator assembly (1) is coaxial to a second axis (9′) of the second ventilator assembly (1′), and a third axis (11) of the first ventilator assembly (1) is coaxial to a third axis (11′) of the second ventilator assembly (1′).
Numbered Paragraph 7. The ventilation system according to Numbered Paragraph 6, characterized in that the two ventilator assemblies (1, 1′) are mirror-symmetrical to one another.
Numbered Paragraph 8. The ventilation system according to Numbered Paragraph 6 or 7, characterized in that each ventilator assembly (1, 1′) has an intake nozzle (17, 17′), the outlets of which are between the two fans (2, 2′) in the two ventilator assemblies (1, 1′).
Numbered Paragraph 9. A motor vehicle (16) that has a ventilation system (18) according to any of the Numbered Paragraphs 6 to 8.
Numbered Paragraph 10. The motor vehicle according to Numbered Paragraph 9, characterized in that the ventilation system (18) is in a central console in the motor vehicle (16).

1-10. (canceled)

11. A ventilator assembly, comprising
at least one fan, and
a diffusor, which opens into at least a first air discharge channel, a second air discharge channel, and a third air discharge channel,
further comprising a first louvre that can pivot about a first axis is positioned in the first air discharge channel, a second louvre that can pivot about a second axis is positioned in the second air discharge channel, and a third louvre that can pivot about a third axis is positioned in the third air discharge channel, the respective first louvre, second louvre, and third louvre configured to control respective first, second, and third air flows, and wherein the first axis, second axis, and third axis are each parallel to one another.

12. The ventilator assembly according to claim 11, further comprising a first stepper motor configured to pivot the first louvre, a second stepper motor configured to pivot the second louvre, and a third stepper motor configured to pivot the third louvre, wherein each of the first stepper motor, the second stepper motor, and the third stepper motor are positioned on the same sides of the respective first, second, and third air discharge channels.

13. The ventilator assembly according to claim 11, further comprising at least one stepper motor, wherein the at least one stepper motor has a cam plate with which at least two of the first louver, the second louver, and the third louver can be operated.

14. The ventilator assembly according to claim 11, wherein the at least one fan is a radial fan.

15. The ventilator assembly according to claim 11, wherein the first air discharge channel is above the second air discharge channel, and the second air discharge channel is above the third air discharge channel.

16. A ventilation system comprising two ventilator assemblies according to claim 11, wherein the two ventilator assemblies are placed in relation to one another such that a first axis of the first ventilator assembly is coaxial to a first axis of the second ventilator assembly, a second axis of the first ventilator assembly is coaxial to a second axis of the second ventilator assembly, and a third axis of the first ventilator assembly is coaxial to a third axis of the second ventilator assembly.

17. The ventilation system according to claim 16, wherein the two ventilator assemblies are mirror-symmetrical to one another.

18. The ventilation system according to claim 16, wherein each of the two ventilator assemblies comprises an intake nozzle, each intake nozzle further comprises an outlet, wherein the respective outlets of the intake nozzle of each of the two ventilator assemblies are between the fan each of the two ventilator assemblies.

19. A motor vehicle that has a ventilation system according to claim 16.

20. The motor vehicle according to claim 19, wherein the ventilation system is in a central console in the motor vehicle.

21. A motor vehicle that has a ventilation system according to claim 17.

22. The motor vehicle according to claim 21, wherein the ventilation system is in a central console in the motor vehicle.

23. A motor vehicle that has a ventilation system according to claim 18.

24. The motor vehicle according to claim 23, wherein the ventilation system is in a central console in the motor vehicle.
